(19) United States
(12) Patent Application Publication
(10) Pub. No.: US 2026/0274005 A1
(43) Pub. Date: Sep. 17, 2026

(54) LAMINATE FOR TIRE

(71) Applicant: The Yokohama Rubber Co., LTD., Kanagawa (JP)

(72) Inventor: Hirokazu Shibata, Kanagawa (JP)

(21) Appl. No.: 19/168,642

(22) PCT Filed: Mar. 14, 2024
(86) PCT No.: PCT/JP2024/009963

§ 371 Date: Sep. 24, 2025

(30) Foreign Application Priority Data
Mar. 29, 2023 (JP) 2023-053358

(51) Int. Cl. B60C 1/00; B60C 19/00; C09D 7/61

(52) U.S. Cl. CPC B60C 1/00; B60C 19/00; C09D 7/61; B60C 2019/004

(57) ABSTRACT

A multilayer structure for a tire includes: a transponder, a coating rubber layer that coats the transponder, and an adjacent rubber layer layered adjacent to at least one surface of the coating rubber layer, the transponder having an IC board and antennas at both end portions of the IC board, a linear distance between terminals of the antennas at both end portions of the IC board being 30 mm or more and 60 mm or less, the coating rubber layer containing a rubber component, carbon black, calcium carbonate, and oil, and containing 1 to 15 parts by mass of the carbon black and 1 to 80 parts by mass of the calcium carbonate with respect to 100 parts by mass of the rubber component, and an oil extraction amount of the coating rubber layer and an oil extraction amount of the adjacent rubber layer satisfying a predetermined relationship.

### CROSS-REFERENCE TO RELATED APPLICATIONS

This application is a U.S. national stage filing under 35 U.S.C. § 371 of International Patent Application No. PCT/JP2024/009963, filed Mar. 14, 2024, which international application claims the benefit of and priority to Japanese Application No. 2023-053358, filed Mar. 29, 2023, the entire contents of these applications are incorporated herein by reference.

### TECHNICAL FIELD

The present technology relates to a multilayer or laminate structure for a tire in which a transponder is coated and embedded, and a tire including the multilayer structure for a tire.

### BACKGROUND ART

It has been proposed to embed a transponder inside a multilayer structure for a tire for the purpose of identification, management, and the like during manufacture, distribution, use, and the like of tires. For example, Japan Unexamined Patent Publication No. H07-137510 A discloses a pneumatic tire in which a pair of sidewall portions and a crown portion are arranged in a toroidal shape between a pair of bead portions, in which both end portions of an innerliner rubber layer and a chafer rubber layer constituting a rubber layer on a tire inner circumferential surface side in the bead portion are overlapped with each other, an end portion of the chafer rubber layer is arranged to cover an end portion of the innerliner rubber layer, and a transponder is embedded between the innerliner rubber layer and the chafer rubber layer in an orientation in which an axis of the transponder is along a circumferential direction of the tire.

Here, the communication performance of the transponder embedded inside the multilayer structure for a tire is greatly affected by the electrical resistance (particularly, the blended amount of carbon black) of the rubber layer coating the transponder. For example, the lower the blended amount of carbon black in the rubber layer coating the transponder, the better the communication performance of the coated transponder. On the other hand, the blended amount of carbon black in the rubber layer coating the transponder and the like affect the durability of not only the rubber layer but also the entire multilayer structure for a tire constituting the tire. For example, the greater the blended amount of carbon black in the rubber layer coating the transponder, the better the durability of the multilayer structure. That is, the communication performance of the transponder and the durability of the multilayer structure are generally in a trade-off relationship, and there is a problem in terms of obtaining a multilayer structure for a tire or the like having excellent communication performance and durability.

### SUMMARY

The present technology provides a multilayer structure for a tire which is excellent in both the communication performance of an embedded transponder and the durability of the multilayer structure.

The present provides a multilayer structure for a tire including a transponder; a coating rubber layer that coats the transponder; and an adjacent rubber layer layered adjacent to at least one surface of the coating rubber layer, the transponder including an IC board and antennas provided at both end portions of the IC board, a linear distance between terminals of the antennas provided at both end portions of the IC (integrated circuit) board being 30 mm or more and 60 mm or less, the coating rubber layer containing a rubber component, carbon black, calcium carbonate, and oil, and containing 1 to 15 parts by mass of the carbon black and 1 to 80 parts by mass of the calcium carbonate per 100 parts by mass of the rubber component, and an oil extraction amount of the coating rubber layer and an oil extraction amount of the adjacent rubber layer satisfying a predetermined relationship, which has excellent communication performance of the transponder and excellent durability of the multilayer structure.

That is, the present technology includes the following embodiments <1> to <12>.
<1> A multilayer structure for a tire including: a transponder; a coating rubber layer that coats the transponder; and an adjacent rubber layer layered adjacent to at least one surface of the coating rubber layer, the transponder including an IC board and antennas provided at both end portions of the IC board, a linear distance between terminals of the antennas provided at both end portions of the IC board being 30 mm or more and 60 mm or less, the coating rubber layer containing a rubber component, carbon black, calcium carbonate, and oil, and containing 1 to 15 parts by mass of the carbon black and 1 to 80 parts by mass of the calcium carbonate per 100 parts by mass of the rubber component, and an oil extraction amount (O1) of the coating rubber layer and an oil extraction amount (O2) of the adjacent rubber layer satisfying a relationship of Formula (1).

$$0. 5 \leq O 1 / O 2 \leq 2.0 \qquad ( 1 )$$

<2> The multilayer structure for a tire according to <1>, in which the calcium carbonate contained in the coating rubber layer is light calcium carbonate or calcium carbonate surface-treated with a fatty acid metal salt, more preferably light calcium carbonate surface-treated with a fatty acid metal salt.
<3> The multilayer structure for a tire according to <1> or <2>, in which the coating rubber layer contains 5 to 15 parts by mass of the carbon black per 100 parts by mass of the rubber component.
<4> The multilayer structure for a tire according to any one of <1> to <3>, in which the carbon black contained in the coating rubber layer is carbon black having a nitrogen adsorption specific surface area (N₂SA) of 20 to 50 m²/g and a DBP (dibutyl phthalate) absorption amount of less than 100 mL/100 g, more preferably carbon black having a nitrogen adsorption specific surface area (N₂SA) of 25 to 40 m²/g and a DBP absorption amount of less than 90 mL/100 g.
<5> The multilayer structure for a tire according to any one of <1> to <4>, in which a mass ratio (carbon black/calcium carbonate) of the carbon black to the calcium carbonate in the coating rubber layer is more than 0.05, more preferably 0.10 to 5.0, even more preferably 0.10 to 2.0, even more preferably 0.15 to 1.5, and even more preferably 0.15 to less than 1.0.
<6> The multilayer structure for a tire according to any one of <1> to <5>, in which the coating rubber layer contains 5 to 70 parts by mass of the calcium carbonate, more preferably 10 to 60 parts by mass, and even more preferably 30 to 60 parts by mass, per 100 parts by mass of the rubber component.
<7> The multilayer structure for a tire according to any one of <1> to <6>, in which the oil extraction amount (O1) of the coating rubber layer and the oil extraction amount (O2) of the adjacent rubber layer satisfy a relational expression of 0.8≤O1/O2<1.8, or even 1.0≤O1/O2≤1.6.
<8> The multilayer structure for a tire according to any one of <1> to <7>, in which the rubber component of the coating rubber layer includes natural rubber (NR) and/or styrene-butadiene copolymer rubber (SBR).
<9> The multilayer structure for a tire according to any one of <1> to <8>, in which the coating rubber layer includes 1 to 30 parts by mass, more preferably 5 to 20 parts by mass, and even more preferably 5 to 10 parts by mass of the oil per 100 parts by mass of the rubber component.
<10> The multilayer structure for a tire according to any one of <1> to <9>, in which the adjacent rubber layer includes 1 to 30 parts by mass, more preferably 5 to 20 parts by mass, and even more preferably 5 to 15 parts by mass of oil per 100 parts by mass of the rubber component included in the adjacent rubber layer.
<11> The multilayer structure for a tire according to any one of <1> to <10>, in which a layer thickness of the coating rubber layer in a region coating the transponder is 0.3 to 1.5 mm.
<12> A tire including the multilayer structure for a tire according to any one of <1> to <11>.

According to the present technology, a multilayer structure for a tire excellent in both the communication performance of an embedded transponder and the durability of the multilayer structure can be obtained.

### BRIEF DESCRIPTION OF THE DRAWING

The Drawing is a partial cross-sectional schematic view that represents an example of an embodiment of a multilayer structure for a tire according to the present technology.

### DETAILED DESCRIPTION

Embodiments of the present technology will be described below.

The present technology relates to a multilayer structure for a tire comprising a transponder, a coating rubber layer coating the transponder, and an adjacent rubber layer layered adjacent to at least one surface of the coating rubber layer, the transponder including an IC board and an antenna provided at both end portions of the IC board, and the linear distance between the terminals of the antennas provided at both end portions of the IC board is 30 mm to 60 mm, the coating rubber layer contains a rubber component, carbon black, calcium carbonate, and oil, and contains 1 to 15 parts by mass of the carbon black and 1 to 80 parts by mass of the calcium carbonate per 100 parts by mass of the rubber component, and the oil extraction amount of the coating rubber layer and the oil extraction amount of the adjacent rubber layer satisfy a predetermined relationship, and a tire including the multilayer structure for a tire. Hereinafter, these are also referred to as the “multilayer structure for a tire of the present technology” and the “tire of the present technology”.

Note that in the present technology, unless otherwise specified, value ranges indicated using “from . . . to . . . ” or “of . . . to . . . ” mean value ranges in which the value before “to” is a lower limit and the value after “to” is an upper limit.

Hereinafter, the configuration, the components, the contents thereof, and the like of the multilayer structure for a tire of the present technology will be described in detail with reference to the drawings. Note that the dimensional ratios (length, thickness, and the like) and orientations of the members and the like shown in the drawings may differ from the actual dimensional ratios and orientations in order to facilitate understanding of the technology.

### Transponder

The multilayer structure for a tire of the present technology is a multilayer structure for a tire including a rubber layer and a transponder. The transponder is coated with a coating rubber layer described later and embedded in the multilayer structure. Here, the “transponder” means a device or an apparatus for transmitting and receiving data in a non-contact manner.

The transponder in the multilayer structure for a tire of the present technology has an IC board for storing data, and antennas provided at both end portions of the IC board for transmitting and receiving data in a non-contact manner, and a linear distance between the terminals of the antennas provided at both end portions of the IC board is 30 mm or more and 60 mm or less. Here, “both end portions of the IC board” refer to both end portions in a longitudinal direction of the IC board. As a result (particularly, since the linear distance between the terminals of the antennas coated with a predetermined coating rubber layer is within a predetermined range), the transponder has high communication performance in a state of being embedded in the multilayer structure for a tire of the present technology. Therefore, by using this, information relating to the tire can be accurately written or read, and identification, management, and the like can be performed during manufacture, distribution, use, and the like of tires.

As the transponder, for example, a radio frequency identification (RFID) tag can be used. Here, “RFID” refers to an automatic recognition technology including: a reader/writer including an antenna and a controller; and an ID tag including an IC board and an antenna, the automatic recognition technology allowing data to be communicated in a wireless manner.

The overall shape of the transponder is not limited to particular shapes and can use a pillar- or plate-like shape, for example. Also, at least one of the antennas may be bent or curved. In particular, using the transponder 31 having a pillar-like shape illustrated in the Drawing can suitably follow the deformation of the tire in each direction. In the case of this embodiment, the antenna 35 of the transponder 31 is provided so as to protrude from each of both end portions of the IC board 33 and has a spiral shape. This allows the transponder to follow deformation of the tire during travel, improving the durability of the transponder.

Furthermore, the communication performance can be further enhanced by appropriately changing the linear distance between the terminals of the antenna within a predetermined range. The same applies to the length of the antenna itself.

For example, the linear distance between the terminals of the antennas described above is more preferably 35 mm or more, even more preferably 40 mm or more, even more preferably 45 mm or more, and even more preferably 50 mm or more. Here, the “linear distance between the terminals of the antennas” is a distance (length) when the terminals (terminals not connected to the IC board) of the antennas provided at both end portions of the IC board are connected by a straight line. In the embodiment of the Drawing, the length is a distance (length L) of the straight line connecting the respective terminals 35a of the antenna 35.

### Coating Rubber Layer

The multilayer structure for a tire of the present technology further includes a coating rubber layer that coats the transponder described above. Here, “coating the transponder” means that the transponder is entirely surrounded and coated so as not to be exposed (the transponder is entirely coated and layered so that both the front and back surfaces of the transponder are sandwiched). For example, as shown in the Drawing, an embodiment in which the transponder 31 is coated and layered so as to be sandwiched between two coating rubber layers 21 is exemplified. An adhesive may be used for layering and bonding the coating rubber layers. In other words, an adhesive layer made of an adhesive may be disposed between the two coating rubber layers. Note that the Drawing is a partial cross-sectional view (schematic view), and it does not indicate that the side surface of the transponder 31 is exposed. Rather, in this embodiment as well, the entire transponder 31 is coated with the coating rubber layer 21. Therefore, the transponder is thus embedded in the multilayer structure for a tire of the present technology by being coated with the coating rubber layer.

The coating rubber layer contains a rubber component, carbon black, calcium carbonate, and oil. The details of these will be described below.

### Rubber Component

The rubber component contained in the coating rubber layer is not particularly limited, and any known rubber component used in applications such as tires can be used. Although not limited, from the viewpoint of forming a multilayer structure for a tire, it is preferable that the rubber component contains a diene rubber, which is a rubber component having a double bond in the polymer main chain, and it is even more preferable that the rubber component is composed of a diene rubber. Examples of the diene rubber include natural rubber (NR), butadiene rubber (BR), styrene-butadiene copolymer rubber (styrene butadiene rubber, SBR), acrylonitrile-butadiene copolymer rubber (nitrile rubber, NBR), chloroprene rubber (CR), synthetic isoprene rubber (IR), styrene-isoprene copolymer rubber, isoprene-butadiene copolymer rubber, and styrene-butadiene-vinylpyridine terpolymer (VP). It is particularly preferable that the rubber component contained in this coating rubber layer contains NR or SBR.

However, it is also possible to use or combine rubber components other than diene rubber, such as olefin rubber (ethylene propylene rubber, acrylic rubber, and the like), fluororubber, and silicone rubber.

The weight average molecular weight of the diene rubber is preferably 50,000 to 3,000,000, and more preferably 100,000 to 2,000,000. Furthermore, any of the diene rubbers described above may be terminal-modified with an amino group, an amide group, a silyl group, an alkoxysilyl group, a carboxy group, a hydroxy group, or the like, or may be epoxidized.

Here, in the present technology, the “weight average molecular weight” refers to a value measured in terms of standard polystyrene by gel permeation chromatography (GPC) using tetrahydrofuran as a solvent. The GPC measurement is performed at 40° C. using a column (MIXED-B, available from Polymer Laboratories) as a measuring instrument.

### Carbon Black

The carbon black contained in this coating rubber layer is also not particularly limited, and any known carbon black used in applications such as tires can be used. For example, specific examples of carbon black that can be used include various grades such as SAF-HS (Super Abrasion Furnace-High Structure), SAF (Super Abrasion Furnace), ISAF-HS (Intermediate Super Abrasion Furnace-High Structure), ISAF (Intermediate Super Abrasion Furnace), ISAF-LS (Intermediate Super Abrasion Furnace-Low Structure), IISAF-HS Intermediate Intermediate Super Abrasion Furnace-High Structure), HAF-HS (High Abrasion Furnace-High Structure), HAF (High Abrasion Furnace), HAF-LS (High Abrasion Furnace-Low Structure), FEF (Fast Extruding Furnace), GPF (General Purpose Furnace), SRF (Semi-Reinforcing Furnace), FT (Fine Thermal), and MT (Medium Thermal). The carbon black may be used alone or in combination of two or more types. The nitrogen adsorption specific surface area (N₂SA) of the carbon black is preferably 20 to 50 m²/g, and more preferably 25 to 40 m²/g, since the effects of the present technology are more easily achieved. The DBP absorption amount of the carbon black is preferably less than 100 mL/100 g, and more preferably less than 90 mL/100 g, since the effects of the present technology are more easily achieved. In particular, it is more preferable that the carbon black contained in the coating rubber layer has a nitrogen adsorption specific surface area (N₂SA) of 20 to 50 m²/g and a DBP absorption amount of less than 100 mL/100 g.

Note that this “carbon black” refers to carbon fine particles with a diameter of about 3 to 500 nm, which are manufactured under industrial quality control, and the average particle size (the arithmetic mean value of the diameters of the particles photographed with an electron microscope) is more preferably 25 to 250 m, and even more preferably 35 to 100 m. The nitrogen adsorption specific surface area (N₂SA) of the carbon black is a value measured according to JIS (Japanese Industrial Standard) K6217-2:2017. The DBP absorption amount of the carbon black is a value measured according to JIS K6217-4:2017.

The coating rubber layer contains 1 to 15 parts by mass of carbon black per 100 parts by mass of the rubber component contained in the coating rubber layer. The amount of carbon black is more preferably 5 parts by mass or more per 100 parts by mass of the rubber component, and may be more than 5 parts by mass. If the amount of carbon black is less than 1 part by mass per 100 parts by mass of the rubber component, the durability of the multilayer structure for a tire of the present technology will be deteriorated, which is not preferable. If the amount of carbon black is more than 15 parts by mass per 100 parts by mass of the rubber component, the communication performance of the transponder cannot be improved, which is not preferable.

### Calcium Carbonate

The calcium carbonate contained in the coating rubber layer is also not particularly limited, and any known calcium carbonate used for applications such as tires can be used. For example, specific examples of calcium carbonate include light calcium carbonate, heavy calcium carbonate, precipitated calcium carbonate, and surface-treated calcium carbonate. The calcium carbonate may be used alone or in combination of two or more types. The calcium carbonate is more preferably light calcium carbonate or surface-treated calcium carbonate, since the effects of the present technology are more easily achieved. In particular, calcium carbonate surface-treated with a fatty acid metal salt (particularly, light calcium carbonate surface-treated with a fatty acid metal salt) is more preferable, since the dispersibility in the rubber component and the like are improved and the effects of the present technology are more easily achieved.

The “surface-treated calcium carbonate” is calcium carbonate whose surface (particle surface) is treated with another component, whereby the other component reacts with or is adsorbed on the surface. The “calcium carbonate surface-treated with a fatty acid metal salt” is calcium carbonate whose surface (particle surface) is treated with a fatty acid metal salt, whereby the fatty acid metal salt reacts with or is adsorbed on the surface.

Examples of fatty acid metal salts include saturated fatty acid salts such as potassium laurate, potassium myristate, potassium palmitate, sodium palmitate, barium stearate, calcium stearate, zinc stearate, potassium stearate, cobalt (II) stearate, tin (IV) stearate, sodium stearate, and lead (II) stearate; and unsaturated fatty acid salts such as zinc oleate, potassium oleate, cobalt (II) oleate, sodium oleate, and potassium oleate diethanolamine salt. These may be used alone for surface treatment, or two or more may be used in combination. Among these, metal salts (soaps) of mixed acids mainly composed of stearic acid and palmitic acid are preferred in terms of reactivity with calcium carbonate particles, particle stability, dispersibility, ease of availability, cost, and the like.

The coating rubber layer contains 1 to 80 parts by mass of this calcium carbonate together with the above-mentioned carbon black per 100 parts by mass of the rubber component contained in the coating rubber layer. Furthermore, the amount of this calcium carbonate is more preferably 5 parts by mass or more per 100 parts by mass of the above-mentioned rubber component, more preferably 10 parts by mass or more, even more preferably 30 parts by mass or more, and even more preferably more than 55 parts by mass. The upper limit may be 70 parts by mass or less, or 60 parts by mass or less. This allows the communication performance of the embedded transponder and the durability of the multilayer structure to be improved by a synergistic effect with the above-mentioned predetermined amount of carbon black. If the amount of this calcium carbonate is less than 1 part by mass per 100 parts by mass of the above-mentioned rubber component, the durability of the multilayer structure for a tire of the present technology will be deteriorated, which is not preferable. If the amount of this calcium carbonate exceeds 80 parts by mass per 100 parts by mass of the above-mentioned rubber component, the communication performance of the transponder cannot be improved, which is not preferable.

Furthermore, since the synergistic effect between calcium carbonate and carbon black is more easily enhanced in this coating rubber layer, it is more preferable that the mass ratio of carbon black to calcium carbonate (carbon black/calcium carbonate) in this coating rubber layer is more than 0.05. This mass ratio is more preferably 0.10 or more, and even more preferably 0.15 or more. The upper limit is more preferably 5.0 or less, even more preferably 2.0 or less, even more preferably 1.5 or less, even more preferably 1.0 or less, and even more preferably less than 1.0.

### Oil

The oil contained in this coating rubber layer is also not particularly limited, and any known oil (process oil, vegetable oil, and the like) used for applications such as tires can be used. For example, specific examples of oil include petroleum-derived oil and natural-product-derived oil (wood-derived oil, and the like). An example of a petroleum-derived oil is TDAE (Treated Distillate Aromatic Extract) oil (a product of Shell Lubricants Japan Co., Ltd), and an example of a wood-derived oil is pine-derived tall oil (oil obtained during the manufacture of kraft pulp, a product of Harima Chemical Group Co., Ltd), but the oils are not limited to these. The oils may be used alone or in combination of two or more types.

The coating rubber layer preferably contains 1 to 30 parts by mass of the oil per 100 parts by mass of the rubber component contained in the coating rubber layer. Moreover, the amount of the oil is more preferably 5 parts by mass or more per 100 parts by mass of the rubber component. The upper limit is more preferably 20 parts by mass or less, and even more preferably 10 parts by mass or less.

The coating rubber layer preferably contains a vulcanizing agent (for example, sulfur). The coating rubber layer is preferably a vulcanized coating rubber layer. The coating rubber layer may further contain, as optional components, within the range that does not significantly affect the effects of the present technology, appropriate amounts of various additives generally used in rubber compositions, such as resin components (terpene resin, coumarone resin, indene resin, rosin resin, and the like), zinc oxide (zinc white), stearic acid, wax, lecithin, antioxidants, plasticizers, vulcanization accelerators, and vulcanization accelerator assistants.

For example, the content of stearic acid, zinc white, and resin components in the coating rubber layer is preferably 1 to 5 parts by mass per 100 parts by mass of the rubber component contained in the coating rubber layer. The content of sulfur in the coating rubber layer is preferably 2 to 6 parts by mass per 100 parts by mass of the rubber component contained in the coating rubber layer. Furthermore, the content of the vulcanization accelerator in the coating rubber layer, either as a primary accelerator alone or as a blend with a secondary accelerator, is preferably 0.3 to 3.0 parts by mass, more preferably 0.5 to 2.0 parts by mass, per 100 parts by mass of the rubber component contained in the coating rubber layer.

The layer thickness of the coating rubber layer in the region coating the transponder is not limited, but is preferably 0.3 to 1.5 mm, since the effects of the present technology are more easily achieved. Here, the “layer thickness of the coating rubber layer in the region coating the transponder” refers to the layer thickness of each coating rubber layer in the region coating the transponder among the coating rubber layers included in the multilayer structure for a tire of the present technology. In the case of the configuration in which the transponder 31 is sandwiched between two coating rubber layers 21 as in embodiment shown in the Drawing, the thickness does not mean the total thickness of the two layers, but means the thickness of each of the coating rubber layers 21 in the region coating the transponder 31 (the layer thickness on a straight line connecting the transponder 31 and one of the outer surfaces of the coating rubber layers 21 and perpendicular to this outer surface: T1, T2).

### Adjacent Rubber Layer

The multilayer structure for a tire of the present technology further includes an adjacent rubber layer layered adjacent to at least one surface of the coating rubber layer described above. For example, an embodiment of a multilayer structure of five or more layers in which adjacent rubber layers 11 are layered adjacent to both surfaces of the coating rubber layer 21 coating the transponder 31 as shown in the Drawing, an embodiment of a multilayer structure of four or more layers in which adjacent rubber layers 11 are layered adjacent to one surface (one side) of the coating rubber layer 21 coating the transponder 31 (for example, a configuration in which any one of the adjacent rubber layers 11 is not layered in the Drawing), and the like are exemplified. The thickness of the adjacent rubber layer is not particularly limited.

Here, “layered adjacent to” means that the layer is layered without disposing any other layer, including layers other than the rubber layer such as an adhesive layer, between the coating rubber layer and the coating rubber layer. Furthermore, “adjacent to at least one surface of the coating rubber layer” means that the layer is adjacent to at least one surface of the front surface or the back surface of the coating rubber layer that is layered to coat the entire surface of the transponder so as to sandwich both the front and back surfaces of the transponder.

The adjacent rubber layer is not particularly limited in terms of other compounding components as long as it contains a rubber component, but may contain the same components as the coating rubber layer described above. Furthermore, the adjacent rubber layer may also be configured to contain organic fibers (for example, organic fiber cords such as polyester and nylon), metals (for example, steel cords), and the like. The rubber component may also be the same as that of the coating rubber layer described above. Furthermore, it is preferable that the adjacent rubber layer is also a vulcanized adjacent rubber layer. In the multilayer structure for a tire of the present technology, the carbon black content of the adjacent rubber layer is not limited as long as the carbon black content of the coating rubber layer is within the range described above. The adjacent rubber layer may further contain an inorganic filler other than carbon black. Examples of such inorganic fillers include the aforementioned calcium carbonate, silica, magnesium carbonate, clay, mica, talc, alumina, aluminum hydroxide, titanium oxide, calcium sulfate, and barium sulfate.

For example, the content of the carbon black in the adjacent rubber layer is preferably 20 to 100 parts by mass per 100 parts by mass of the rubber component contained in the adjacent rubber layer. The content of stearic acid, zinc oxide, and resin component in the adjacent rubber layer is preferably 1 to 5 parts by mass per 100 parts by mass of the rubber component contained in the adjacent rubber layer. Furthermore, the content of sulfur in the adjacent rubber layer is preferably 2 to 6 parts by mass per 100 parts by mass of the rubber component contained in the adjacent rubber layer. The content of the vulcanization accelerator in the adjacent rubber layer is preferably 0.3 to 3.0 parts by mass, and more preferably 0.5 to 2.0 parts by mass, either as a primary accelerator alone or as a blend with a secondary accelerator, per 100 parts by mass of the rubber component contained in the adjacent rubber layer.

In addition, the adjacent rubber layer preferably contains oil from the viewpoint of easily improving the durability of the multilayer structure for a tire of the present technology. The oil may be the same as that of the coating rubber layer described above. The adjacent rubber layer preferably contains 1 to 30 parts by mass of this oil per 100 parts by mass of the rubber component contained in the adjacent rubber layer. Moreover, the amount of this oil is more preferably 5 parts by mass or more per 100 parts by mass of the above-mentioned rubber component. The upper limit is more preferably 20 parts by mass or less, and even more preferably 15 parts by mass or less.

### Ratio of Oil Extraction Amount

The multilayer structure for a tire of the present technology is further configured so that an oil extraction amount (O1) of the coating rubber layer and an oil extraction amount (O2) of the adjacent rubber layer satisfy the relationship of Formula (1). As a result, oil migration is less likely to occur between the coating rubber layer and the adjacent rubber layer during manufacture (for example, during vulcanization press) and after manufacture, and the like, and the durability of the multilayer structure can be maintained at a high level.

$$0.5 \leq O 1 / O 2 \leq 2.0 \qquad ( 1 )$$

The lower limit of Formula (1) is more preferably 0.8 or more, and even more preferably 1.0 or more, since the effects of the present technology are more easily achieved. The upper limit is more preferably 1.8 or less, and even more preferably 1.6 or less. For example, Formula (1) may be 0.8≤O1/O2≤1.8, or 1.0≤O1/O2≤1.6.

The oil extraction amount of the coating rubber layer and the oil extraction amount of the adjacent rubber layer are both values measured by a Soxhlet extraction method using acetone as an extraction solvent. Even if the adjacent rubber layer does not contain oil, the oil extraction amount (O2) is measured by the above method, although it is small. Therefore, the adjacent rubber layer may be configured not to contain oil.

The tire of the present technology having a predetermined transponder embedded therein can be obtained by using such a multilayer structure for a tire of the present technology. For example, a transponder coated with a predetermined coating rubber layer is embedded extending along the tire circumferential direction between a carcass layer (a layer including cords forming the framework of a tire) and an innerliner layer (a layer corresponding to a tube), both of which have a predetermined oil extraction amount, and an unvulcanized tire is manufactured including the multilayer structure of the above-mentioned configuration, and the tire of the present technology including the multilayer structure for a tire of the present technology can be manufactured by vulcanizing (for example, vulcanization pressing) the unvulcanized tire. However, the embedding position of the transponder is not limited to this, and the transponder can be arbitrarily positioned as long as it does not deteriorate the function of the tire. Alternatively, It may also be positioned so that one surface of the coating rubber layer is exposed.

The tire of the present technology is preferably a pneumatic tire. The gas to be filled in the pneumatic tire can be, for example, air, inert gas such as nitrogen, argon, helium, and other gases.

The multilayer structure for a tire of the present technology and the tire of the present technology, which are configured as described above, are excellent in both the communication performance of the embedded transponder and the durability of the multilayer structure (that is, the durability of the tire).

Hereinafter, Examples of the present technology will be described, but the present technology is not limited to the following examples, and various modifications can be made within the technical concept of the present technology.

### Examples

### Manufacture and Evaluation of Tire

A tire was manufactured that includes a multilayer structure as shown in the Drawing, using a transponder (RFID tag) which has an IC board and antennas provided at both end portions of the IC board, and in which a linear distance between the terminals of the antennas is about 55 mm, a coating rubber layer having the composition shown in the upper part of Table 2 or the upper part of Table 3 below, and an adjacent rubber layer having the composition shown in Table 1 below.

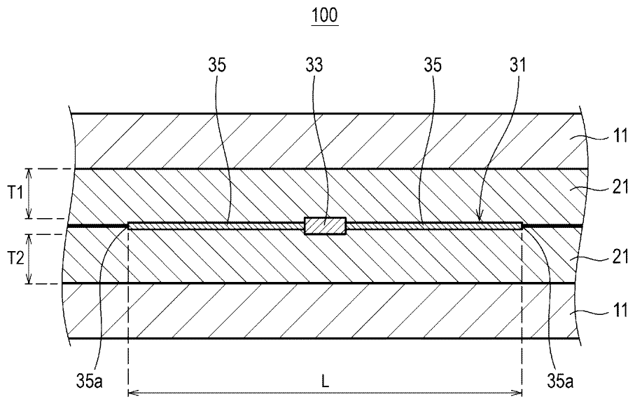

Specifically, first, a mixed rubber was formed using the components (excluding sulfur and vulcanization accelerator) in parts by mass shown in the upper part of Table 2 and the upper part of Table 3 below, and then the sulfur and vulcanization accelerator shown in the upper part of Table 2 or the upper part of Table 3 below were mixed with the mixed rubber and molded into a predetermined sheet shape to manufacture an unvulcanized rubber sheet (coating rubber layer). The transponder described above was then coated with one of these rubber sheets as shown in FIG. 1. Furthermore, a mixed rubber was formed using the components (excluding sulfur and vulcanization accelerator) in parts by mass shown in Table 1 below, and then the sulfur and vulcanization accelerator shown in Table 1 below were mixed with the mixed rubber and molded into a predetermined sheet shape to manufacture an unvulcanized rubber sheet (adjacent rubber layer). These rubber sheets were then layered to form the multilayer structures shown in Tables 2 and 3 below, and unvulcanized tires were formed so that the transponder was disposed between the carcass layer and the innerliner layer, which were then vulcanized under the conditions of a vulcanization temperature of 185° C., a vulcanization time of 15 minutes, and a pressure of 2.3 MPa, to manufacture tires (pneumatic radial tires) of Examples 1 to 12 and Comparative Examples 1 to 23.

The oil extraction amount (O2) of the adjacent rubber layer and the oil extraction amount (O1) of the coating rubber layer were both measured by a Soxhlet extraction method using acetone as an extraction solvent.

Then, for the tires of Examples 1 to 12 and Comparative Examples 1 to 23 thus obtained, the transponder communication performance and tire durability were evaluated as follows.

### Communication Performance

For each tire, a communication operation with the transponder was performed using a reader/writer. Specifically, the maximum communication distance was measured with the reader/writer at a power output of 250 mW and a carrier frequency of from 860 MHz to 960 MHz. Evaluation results are expressed as index values with Comparative Example 1 being assigned an index value of 100. Larger index values indicate superior communication performance.

### Durability

Each tire was mounted on a wheel of a standard rim, the wheel was mounted on a test vehicle, and a travel test of driving over a curb having a height of 100 mm was performed at an air pressure of 230 kPa and a traveling speed of 20 km/h. After traveling, the portion of the tire outer surface corresponding to the arrangement section for the transponder was checked for damage. This test was conducted multiple times, and the evaluation results were expressed as index values with Comparative Example 1 being assigned an index value of 100 for the number of times damage occurred. Larger index values indicate superior durability.

TABLE 1

| | A | B | C | D | E | F |
|---|---|---|---|---|---|---|
| NR | 50 | 50 | 50 | 50 | 50 | 50 |
| SBR | 50 | 50 | 50 | 50 | 50 | 50 |
| Carbon black | 60 | 60 | 60 | 60 | 60 | 60 |
| Oil | 0 | 2 | 4 | 6 | 8 | 10 |
| Zinc oxide | 3 | 3 | 3 | 3 | 3 | 3 |
| Stearic acid | 2 | 2 | 2 | 2 | 2 | 2 |
| Terpene resin | 2 | 2 | 2 | 2 | 2 | 2 |
| Sulfur | 4 | 4 | 4 | 4 | 4 | 4 |
| Vulcanization accelerator | 1 | 1 | 1 | 1 | 1 | 1 |
| Oil extraction amount (O2) | 0.01 | 0.02 | 0.03 | 0.04 | 0.06 | 0.07 |

TABLE 2

| | Comparative | Comparative | Comparative | Comparative | Comparative | Comparative |
|---|---|---|---|---|---|---|
| | Example 1 | Example 2 | Example 3 | Example 4 | Example 5 | Example 6 |
| NR | 50 | 50 | 50 | 50 | 50 | 50 |
| SBR | 50 | 50 | 50 | 50 | 50 | 50 |
| Carbon black | 20 | 0 | 0 | 0 | 1 | 1 |
| Calcium carbonate 1 | — | — | — | — | — | — |
| Calcium carbonate 2 | — | — | — | — | — | — |
| Oil | 8 | 8 | 8 | 8 | 8 | 8 |
| Zinc oxide | 3 | 3 | 3 | 3 | 3 | 3 |
| Stearic acid | 2 | 2 | 2 | 2 | 2 | 2 |
| Terpene resin | 2 | 2 | 2 | 2 | 2 | 2 |
| Sulfur | 4 | 4 | 4 | 4 | 4 | 4 |
| Vulcanization accelerator | 1 | 1 | 1 | 1 | 1 | 1 |
| Adjacent rubber layer | A | A | C | E | A | C |
| O1/O2 | 6.1 | 7.2 | 2.4 | 1.5 | 7.1 | 2.4 |
| Communication performance | 100 | 112 | 112 | 112 | 112 | 112 |
| Durability | 100 | 71 | 71 | 86 | 73 | 73 |
| | Comparative | Comparative | Comparative | Comparative | Comparative | |
| | Example 7 | Example 8 | Example 9 | Example 10 | Example 11 | Example 1 |
| NR | 50 | 50 | 50 | 50 | 50 | 50 |
| SBR | 50 | 50 | 50 | 50 | 50 | 50 |
| Carbon black | 1 | 4 | 4 | 4 | 20 | 15 |
| Calcium carbonate 1 | — | — | — | — | — | 10 |
| Calcium carbonate 2 | — | — | — | — | — | — |
| Oil | 8 | 8 | 8 | 8 | 8 | 8 |
| Zinc oxide | 3 | 3 | 3 | 3 | 3 | 3 |
| Stearic acid | 2 | 2 | 2 | 2 | 2 | 2 |
| Terpene resin | 2 | 2 | 2 | 2 | 2 | 2 |
| Sulfur | 4 | 4 | 4 | 4 | 4 | 4 |
| Vulcanization accelerator | 1 | 1 | 1 | 1 | 1 | 1 |
| Adjacent rubber layer | E | A | C | E | C | E |
| O1/O2 | 1.5 | 6.4 | 2.2 | 1.3 | 2.1 | 1.3 |
| Communication performance | 112 | 107 | 107 | 107 | 100 | 107 |
| Durability | 87 | 86 | 86 | 100 | 100 | 143 |

| | | | Comparative | Comparative | Comparative |
|---|---|---|---|---|---|
| | Example 2 | Example 3 | Example 12 | Example 13 | Example 14 |
| NR | 50 | 50 | 50 | 50 | 50 |
| SBR | 50 | 50 | 50 | 50 | 50 |
| Carbon black | 15 | 15 | 15 | 15 | 15 |
| Calcium carbonate 1 | 10 | 10 | 10 | 10 | 10 |
| Calcium carbonate 2 | — | — | — | — | — |
| Oil | 8 | 8 | 8 | 8 | 8 |
| Zinc oxide | 3 | 3 | 3 | 3 | 3 |
| Stearic acid | 2 | 2 | 2 | 2 | 2 |
| Terpene resin | 2 | 2 | 2 | 2 | 2 |
| Sulfur | 4 | 4 | 4 | 4 | 4 |
| Vulcanization accelerator | 1 | 1 | 1 | 1 | 1 |
| Adjacent rubber layer | F | D | B | C | A |
| O1/O2 | 1.1 | 1.6 | 3.2 | 2.2 | 6.4 |
| Communication performance | 107 | 107 | 107 | 107 | 107 |
| Durability | 143 | 143 | 100 | 100 | 100 |

TABLE 3

| | | Comparative | Comparative | | | Comparative |
|---|---|---|---|---|---|---|
| | Example 4 | Example 15 | Example 16 | Example 5 | Example 6 | Example 17 |
| NR | 50 | 50 | 50 | 50 | 50 | 50 |
| SBR | 50 | 50 | 50 | 50 | 50 | 50 |
| Carbon black | 15 | 15 | 15 | 15 | 15 | 15 |
| Calcium carbonate 1 | 40 | 40 | 40 | 40 | 40 | 40 |
| Calcium carbonate 2 | — | — | — | — | — | — |
| Oil | 8 | 8 | 8 | 8 | 8 | 8 |
| Zinc oxide | 3 | 3 | 3 | 3 | 3 | 3 |
| Stearic acid | 2 | 2 | 2 | 2 | 2 | 2 |
| Terpene resin | 2 | 2 | 2 | 2 | 2 | 2 |
| Sulfur | 4 | 4 | 4 | 4 | 4 | 4 |
| Vulcanization accelerator | 1 | 1 | 1 | 1 | 1 | 1 |
| Adjacent rubber layer | E | C | A | F | D | B |
| O1/O2 | 1.3 | 2.2 | 6.4 | 1.1 | 1.6 | 3.2 |
| Communication performance | 106 | 106 | 106 | 106 | 106 | 106 |
| Durability | 144 | 100 | 100 | 110 | 143 | 100 |

| | | Comparative | Comparative | Comparative | | |
|---|---|---|---|---|---|---|
| | Example 7 | Example 18 | Example 19 | Example 20 | Example 8 | Example 9 |
| NR | 50 | 50 | 50 | 50 | 50 | 50 |
| SBR | 50 | 50 | 50 | 50 | 50 | 50 |
| Carbon black | 15 | 15 | 15 | 15 | 15 | 15 |
| Calcium carbonate 1 | 80 | 80 | 80 | 80 | 80 | 80 |
| Calcium carbonate 2 | — | — | — | — | — | — |
| Oil | 8 | 8 | 8 | 8 | 8 | 8 |
| Zinc oxide | 3 | 3 | 3 | 3 | 3 | 3 |
| Stearic acid | 2 | 2 | 2 | 2 | 2 | 2 |
| Terpene resin | 2 | 2 | 2 | 2 | 2 | 2 |
| Sulfur | 4 | 4 | 4 | 4 | 4 | 4 |
| Vulcanization accelerator | 1 | 1 | 1 | 1 | 1 | 1 |
| Adjacent rubber layer | E | C | A | B | D | F |
| O1/O2 | 1.3 | 2.2 | 6.4 | 3.2 | 1.6 | 1.1 |
| Communication performance | 103 | 103 | 103 | 103 | 103 | 103 |
| Durability | 147 | 100 | 95 | 100 | 144 | 144 |

| | Comparative | Comparative | Comparative | Example | Example | Example |
|---|---|---|---|---|---|---|
| | Example 21 | Example 22 | Example 23 | 10 | 11 | 12 |
| NR | 50 | 50 | 50 | 50 | 50 | 50 |
| SBR | 50 | 50 | 50 | 50 | 50 | 50 |
| Carbon black | 15 | 15 | 15 | 15 | 5 | 10 |
| Calcium carbonate 1 | 100 | 100 | 100 | — | 10 | 10 |
| Calcium carbonate 2 | — | — | — | 10 | — | — |
| Oil | 8 | 8 | 8 | 8 | 8 | 8 |
| Zinc oxide | 3 | 3 | 3 | 3 | 3 | 3 |
| Stearic acid | 2 | 2 | 2 | 2 | 2 | 2 |
| Terpene resin | 2 | 2 | 2 | 2 | 2 | 2 |
| Sulfur | 4 | 4 | 4 | 4 | 4 | 4 |
| Vulcanization accelerator | 1 | 1 | 1 | 1 | 1 | 1 |
| Adjacent rubber layer | E | C | A | E | F | F |
| O1/O2 | 1.3 | 2.2 | 6.4 | 1.3 | 1.1 | 1.1 |
| Communication performance | 100 | 100 | 100 | 107 | 107 | 107 |
| Durability | 150 | 100 | 100 | 150 | 143 | 143 |

The detailed contents of each component and the like in Tables 1 to 3 are as follows.
NR: Natural rubber (STR 20, available from Von Bundit Co., Ltd.)
SBR: Styrene-butadiene copolymer rubber (Nipol 1502, available from ZEON CORPORATION)
Carbon black: Nitelon #55S (GPF, nitrogen adsorption specific surface area (N₂SA): 26 m²/g, DBP absorption amount: 88 mL/100 g, average particle size: 56 m, available from NSCC Carbon Co., Ltd.)
Oil: Extract 4S (TDAE oil, available from Shell Lubricants Japan K.K.)
Zinc oxide: Zinc oxide (ZnO, available from Seido Chemical Industry Co., Ltd)
Stearic acid: Stearic acid YR (available from NOF Corporation)
Terpene resin: Tackifier (available from Yasuhara Chemical Co., Ltd.)
Sulfur: Myucron OT-20 (available from SHIKOKU CHEMICALS CORPORATION)
Vulcanization accelerator: Noccela NS-P (available from Ouchi Shinko Chemical Industry Co., Ltd)
Calcium carbonate 1: Light calcium carbonate (no surface treatment, available from Maruo Calcium Co., Ltd)
Calcium carbonate 2: MSK-V (light calcium carbonate surface-treated with fatty acid metal salt, available from Maruo Calcium Co., Ltd)
Oil extraction amount (O2): Oil extraction amount (O2) of adjacent rubber layer
O1/O2: Oil extraction amount (O1) of coating rubber layer/Oil extraction amount (O2) of adjacent rubber layer

From these results, it was shown that by making a tire containing a multilayer structure in which a predetermined amount of carbon black, a predetermined amount of calcium carbonate, and oil are contained in the coating rubber layer that coats a predetermined transponder, and the ratio of the oil extraction amount of this coating rubber layer to the oil extraction amount of the adjacent rubber layer is within a predetermined range, a transponder-embedded tire excellent in the communication performance of the transponder and the durability of the tire (durability of multilayer structure for a tire) is obtained.

In addition, the tire durability was not improved in Comparative Examples 1 to 11, in which the coating rubber layer does not contain calcium carbonate, and the tire durability was not improved in Comparative Examples 1 to 3, 5 to 6, 8 to 9, 11 to 20, and 22 to 23, in which O1/O2 was not within the predetermined range. Furthermore, the communication performance of the transponder was not improved in Comparative Examples 1 and 11, in which the carbon black content of the coating rubber layer was higher than the predetermined amount, and Comparative Examples 21 to 23, in which the calcium carbonate content of the coating rubber layer was higher than the predetermined amount.

1. A multilayer structure for a tire comprising:
a transponder;
a coating rubber layer that coats the transponder; and
an adjacent rubber layer layered adjacent to at least one surface of the coating rubber layer,
the transponder comprising an IC board and antennas provided at both end portions of the IC board,
a linear distance between terminals of the antennas provided at both end portions of the IC board being 30 mm or more and 60 mm or less,
the coating rubber layer containing a rubber component, carbon black, calcium carbonate, and oil, and containing 1 to 15 parts by mass of the carbon black and 1 to 80 parts by mass of the calcium carbonate per 100 parts by mass of the rubber component, and an oil extraction amount (O1) of the coating rubber layer and an oil extraction amount (O2) of the adjacent rubber layer satisfying a relationship 0.5≤O1/O2≤2.0.

2. The multilayer structure for a tire according to claim 1, wherein the calcium carbonate contained in the coating rubber layer is calcium carbonate surface-treated with a fatty acid metal salt.

3. The multilayer structure for a tire according to claim 1, wherein the coating rubber layer contains 5 to 15 parts by mass of the carbon black per 100 parts by mass of the rubber component.

4. The multilayer structure for a tire according to claim 1, wherein the carbon black contained in the coating rubber layer is carbon black having a nitrogen adsorption specific surface area (N₂SA) of 20 to 50 m²/g and a DBP absorption amount of less than 100 mL/100 g.

5. The multilayer structure for a tire according to claim 1, wherein a mass ratio (carbon black/calcium carbonate) of the carbon black to the calcium carbonate in the coating rubber layer is greater than 0.05.

6. A tire comprising the multilayer structure for a tire according to claim 1.

7. The multilayer structure for a tire according to claim 2, wherein the coating rubber layer contains 5 to 15 parts by mass of the carbon black per 100 parts by mass of the rubber component.

8. The multilayer structure for a tire according to claim 2, wherein the carbon black contained in the coating rubber layer is carbon black having a nitrogen adsorption specific surface area (N₂SA) of 20 to 50 m²/g and a DBP absorption amount of less than 100 mL/100 g.

9. The multilayer structure for a tire according to claim 2, wherein a mass ratio (carbon black/calcium carbonate) of the carbon black to the calcium carbonate in the coating rubber layer is greater than 0.05.

10. A tire comprising the multilayer structure for a tire according to claim 2.
